(19) United States
(12) Patent Application Publication
(10) Pub. No.: US 2025/0391098 A1
(43) Pub. Date: Dec. 25, 2025

(54) RAY TRACING ENHANCEMENTS WITH CONE ANGLE

(71) Applicant: Advanced Micro Devices, Inc., Santa Clara, CA (US)

(72) Inventors: David Ronald Oldcorn, Milton Keynes (GB); Holger Gruen, Munich (DE)

(73) Assignee: Advanced Micro Devices, Inc., Santa Clara, CA (US)

(21) Appl. No.: 18/752,057

(22) Filed: Jun. 24, 2024

(51) Int. Cl. G06T 15/06; G06T 15/00

(52) U.S. Cl. CPC G06T 15/06; G06T 15/005

(57) ABSTRACT

In ray tracing, a ray is cast into a scene defined by a bounding volume hierarchy. Part of this cast includes determining a time or distance to intersection of the ray against geometry such as a bounding volume. It would be useful to use such a distance to perform subsequent operations. However, the raw time to intersection is inflexible. Thus, use of a separate parameter called a cone angle value to perform operations such as selecting a geometry level of detail is provided. The cone angle defines the angle at the apex of a cone with an axis congruent with the ray. This cone has a radius at its base which is referred to as a cone characterization value. This cone characterization value can be used for subsequent operations such as level of detail selection.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrate example operations that utilize a cone angle value, according to an example;

FIG. 6A illustrates an example in which the ray tracing pipeline uses the cone characterization value to select a geometry level of detail;

FIG. 6B represents an alternative or additional operation that the ray tracing pipeline performs based on the determined cone characterization value;

FIG. 7 illustrates operations for selecting geometry corresponding to a particular level of detail based on a cone characterization value while traversing through the bounding volume hierarchy, according to an example; and

FIG. 8 is a flow diagram of a method for performing rendering operations using a cone angle value, according to an example.

### DETAILED DESCRIPTION

In ray tracing, a ray is cast into a scene defined by a bounding volume hierarchy (“BVH”). Part of this cast includes determining a time or distance to intersection of the ray against geometry such as a bounding volume. It would be useful to use such a distance to perform subsequent operations such as selecting a geometry level of detail or selecting a shader to execute. However, the raw time to intersection is inflexible.

This disclosure provides for use of a separate parameter called a cone angle value to perform operations such as selecting a geometry level of detail. The cone angle defines the angle at the apex of a virtual cone with an axis congruent with the ray being cast. This cone has a radius at its base which is referred to as a cone characterization value herein. This radius can be thought of as the footprint of the ray on geometry being rendered. If the ray has a large footprint, then a lower level of detail is appropriate, and if the ray has a small footprint, then a higher level of detail is appropriate. This cone characterization value can be used for subsequent operations such as level of detail selection. This value is more flexible than time to intersection because it depends both on time to intersection and on an adjustable cone angle. Software such as a shader or application can vary this cone angle to adjust the level of detail selected.

This disclosure also provides for use of the cone characterization value for other purposes such as selection of which shader to execute. Specifically, the cone characterization value indicates how detailed rendering should be, and with lower detail level, a less complex shader can be used than with a higher detail level.

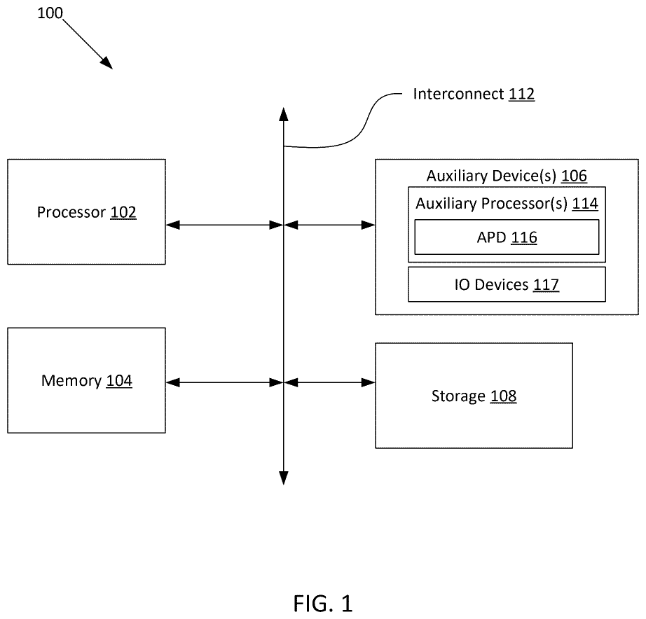

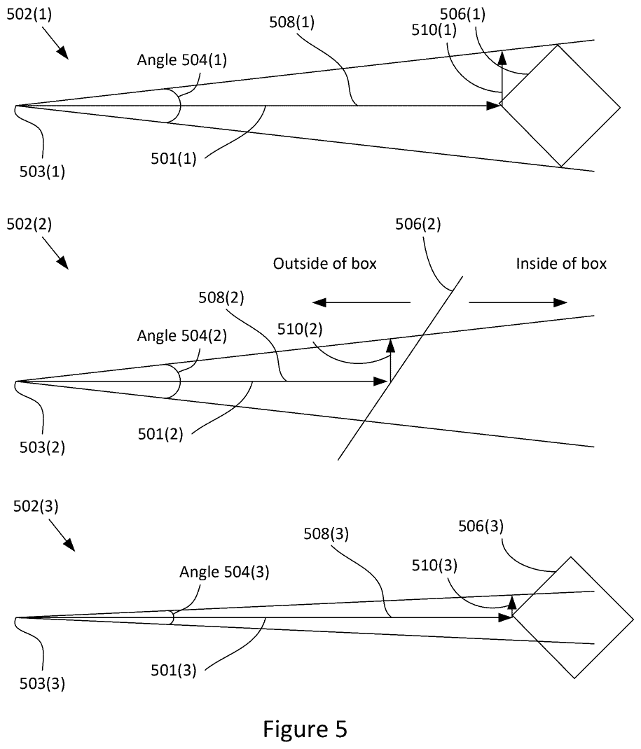

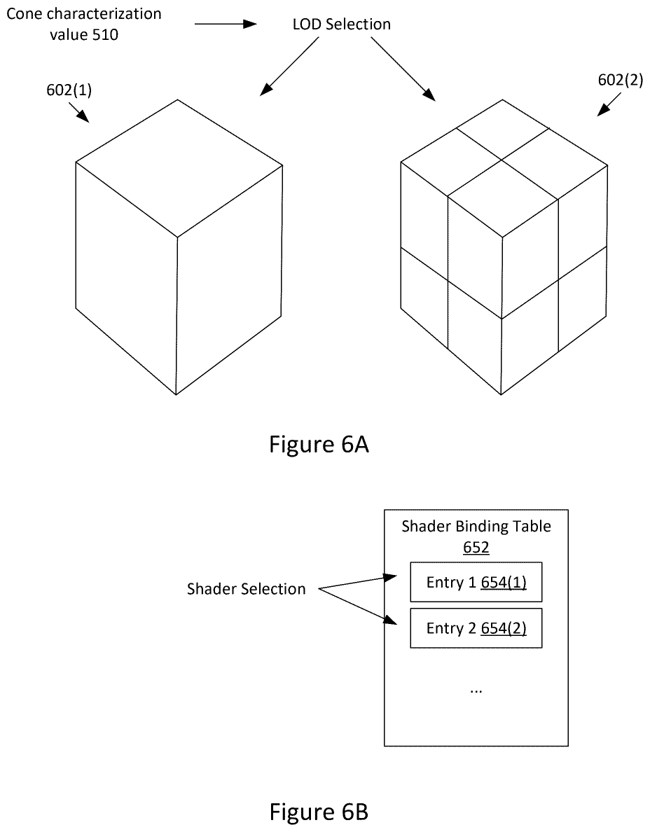

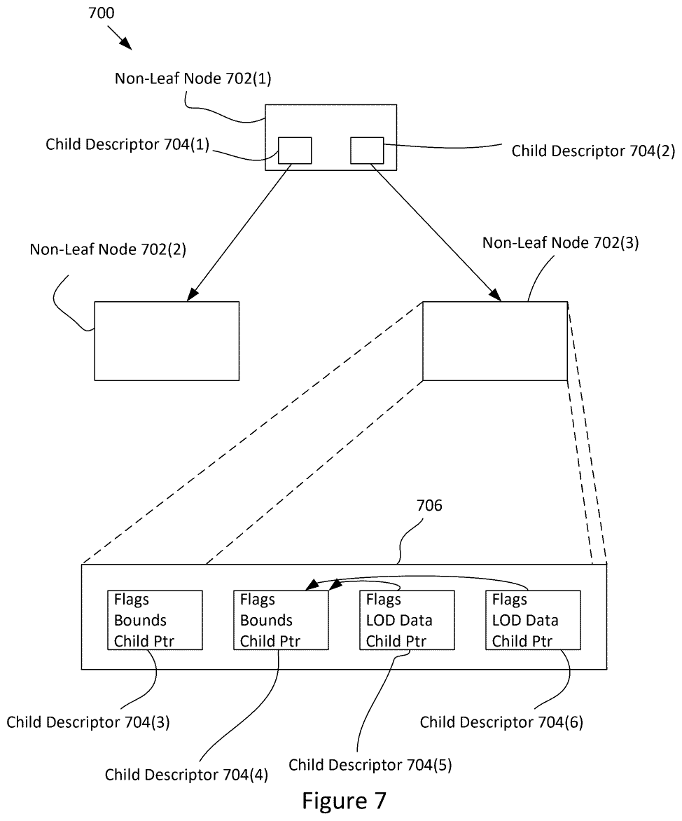

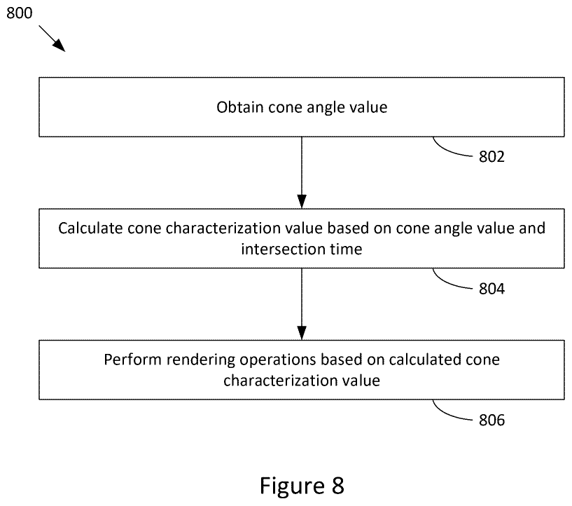

FIGS. 1-4 of the application describe ray tracing in general. FIG. 5 illustrates how cone angle and time to intersection produce a cone characterization value. FIGS. 6A-6B illustrate level of detail selection and shader selection based on the con characterization value. FIG. 7 illustrates a detailed technique for performing level of detail selection. FIG. 8 illustrates a method for performing operations using a cone characterization value.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

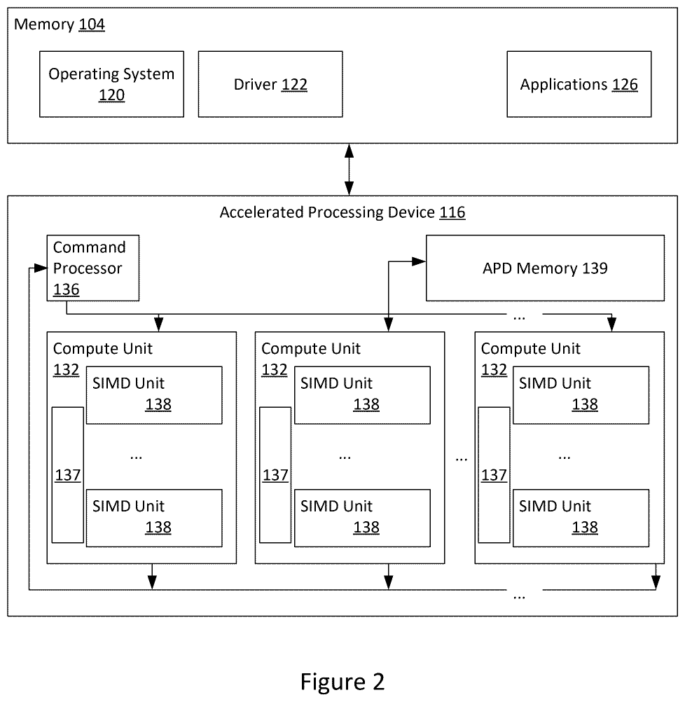

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (AI) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or AI operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

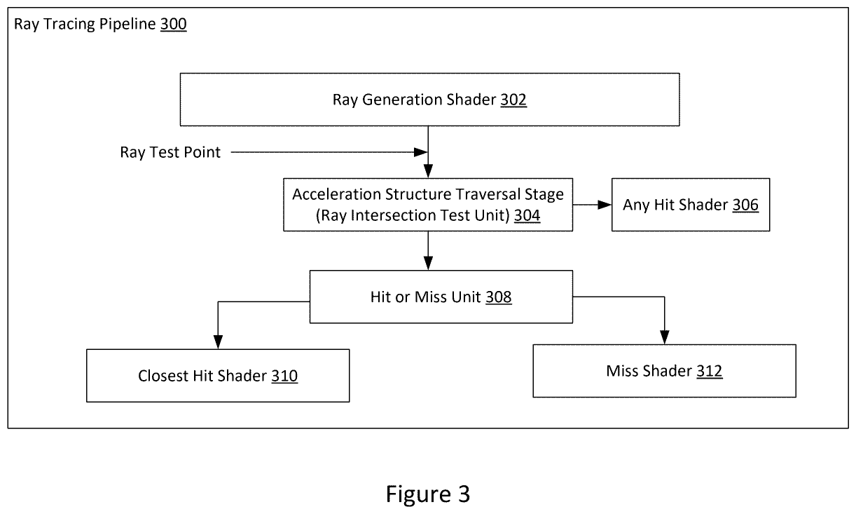

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

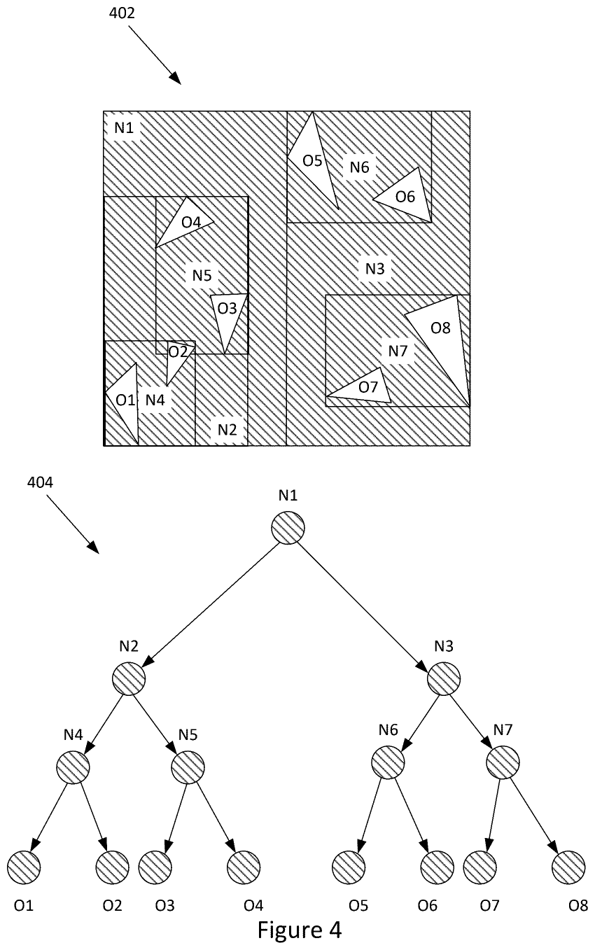

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

Ray tracing operations can be improved through use of a cone angle factor that corresponds roughly to intersection time of a cast ray. When a ray is cast and tested for intersection, such a test determines a value “t” which indicates the time from the origin of the ray to the point of intersection (e.g., point of entry or exit into a bounding volume of a non-leaf node).

It is useful to use this time to intersection to perform various operations such as determining geometry level of detail (“LOD”), determining which shader to invoke (such as for the any hit shader or closest hit shader), or other operations such as determining which texture LOD to select, and operations inside a given shader. However, the time to intersection output by the ray intersection operations is not quite suitable for direct use for this purpose. For instance, this distance is inflexible in that it cannot be adjusted as needed by software or hardware. Additionally, direct use of the distance for LOD selection can produce artifacts such as where the geometry in question is a long distance from the ray origin, but where the effects of the geometry are more visible, perhaps because they are closer to the camera, and so need a higher level of detail (for example, shadows cast by a distant object towards the camera). Thus, the present disclosure provides techniques for obtaining and using a value that is based on intersection distance but which is also adjustable and flexible for a variety of uses. Herein, this value is referred to as a cone characterization value. In general, the cone characterization value acts as a generally available measure indicating how much computation to expend in further calculations.

FIG. 5 illustrate example operations 502 that utilize a cone angle value 504, according to an example. These operations 502 represent intersection tests for a ray, performed against a bounding box of a non-leaf node (e.g., a node marked “N” of FIG. 4). The box for which this text is being performed in the illustrated example is marked as bounding box 506. A cone angle 504 is specified for each operation 502.

This cone angle 504 is a value that can be specified in any technically feasible manner, such as by a shader that requests the ray intersection test be performed, by an application that initially triggers execution of the ray tracing operations, or in any other technically feasible manner. A time 508 (also sometimes “distance” herein) to intersection with the box 506 is shown, and a cone characterization value 510 is shown as well. Although the distance to intersection is the distance to intersection with the closest point of the box 506, it should be understood that this is not required and that the present disclosure contemplates any of a variety of techniques for calculating such a distance.

The cone angle 504 represents a value that is used to vary how the distance 508 metric is considered for subsequent processing. In one example, the combination of the cone angle 504 and distance 508 produces a resulting cone characterization value 510. The ray tracing pipeline 300 then compares this cone characterization value 510 with another value to determine the level of detail with which to rendering geometry associated with the bounding box. In an example, the ray tracing pipeline 300 accepts a cone angle value 504 and performs a ray intersection test with a ray against a bounding box, determining a time to intersection with the box. The ray tracing pipeline 300 determines a cone characterization value 510 based on the time to intersection and the cone angle value 504 and compares this cone characterization value 510 to a comparison value to select a geometry level of detail. In some examples, the cone characterization value 510 represents the radius of the base of a cone having a central axis congruent with the ray 501 being cast, an apex at the point of origin 503 of the ray 501 being cast, and a cone angle (angle between cone walls at the apex) equal to the cone angle value 504. It is possible to apply a time to intersection bias that allows the final cone characterization value to be different than if the “raw” time to intersection, from the ray origin to actual point of intersection, were used. More specifically, it is possible to “enlarge” the cone past the ray origin or “shrink” the cone to achieve a desired result such as modifying the cone characterization value 510 as needed. This represents an additional modification (other than controlling the cone angle value 504) that allows for customization of the ray tracing operation. This modification to the time to intersection bias is provided in any technically feasible manner, such as by a shader program or application. In various examples, the comparison value-the value against which the cone characterization value 510 is compared-is provided within the BVH itself, is provided or calculated by a shader program, is provided by an application, or is provided in any technically feasible manner.

As stated above, in various examples where the cone characterization value 510 is used to select a geometry level of detail, the ray tracing pipeline 300 compares this value to another value (a “comparison value”) to select a geometry LOD. In some examples, the larger the cone characterization value in comparison to this comparison value, the less detailed the level of detail. In a concrete example, the comparison value is a value that characterizes the size of the bounding box for which the intersection test is being performed. In such an example, the cone characterization value 510 can be thought of as the “footprint” of the cone on that bounding box. In such an example, if the footprint is very small relative to the size of the box, then the level of detail must be high, because the ray “sees” only a small portion of the underlying geometry of the bounding box. By contrast, if the cone characterization value 510 is very large, then the ray “sees” a much larger portion of the underlying geometry and the geometry LOD can be smaller. As can be seen, the cone angle value 504 is an adjustment to this parameter that allows the selected level of detail to vary based on needs even with the same bounding box. It is possible to use an anisotropic LOD comparison, which could account for bounding volumes that are much larger in one dimension than in another. In such examples, the comparison value that the ray tracing pipeline 300 compares the cone characterization value against depends on the direction of the ray with respect to the bounding volume. If the “footprint” of the bounding volume is relatively smaller (i.e., a narrower part of the bounding volume faces the ray origin), then the comparison value would be smaller than if the footprint of the bounding volume were relatively larger.

FIG. 5 illustrates three different examples of the above. In operation 1 502(1), a first ray 501(1) is cast against a bounding box 506(1). The distance 508(1) illustrates the time to intersection of the ray 501(1) with the bounding box 506(1). This distance 508(1), in combination with the cone angle value 504(1), determines a cone characterization value 510(1). As can be seen in the depiction of operation 502(1), this cone characterization value 510(1) has a size that is relatively similar to the size of the bounding box 506(1). For this operation 502(1), based on this comparison, the ray tracing pipeline 300 assigns a level of detail to subsequent rendering operations that is relatively low.

In operation 502(2), a similar operation occurs, but the bounding box is much larger. In this situation, the cone characterization value 510(2) is considerably smaller in comparison with the size of the bounding box 506(2). Thus, the ray tracing pipeline 300 selects a more detailed geometry LOD than for operation 502(1).

For operation 502(3), a similar operation occurs, with the same bounding box 506(1) as in operation 502(1), but with a smaller cone angle value 504(3). In this case, the resulting cone characterization value 510(1) is smaller than in operation 502(1) and thus smaller in comparison to the size of the bounding box 506(3). Thus, the resulting level of detail for operation 502(3) is more detailed than the level of detail for operation 502(1).

It should be understood that the ray tracing pipeline 300 uses the selected geometry LOD in any technically feasible manner. In one example, the ray tracing pipeline 300 selects geometry to render based on this LOD, where the selected geometry has the appropriate LOD. In an example, the BVH that is being traversed for the ray includes a plurality of instances for the bounding box, where each instance has a different LOD. An instance is a portion of a two-level BVH that can be referenced by a pointer in a top level BVH. In some situations, “instances” are referred to as “bottom level BVHs,” where the portion of the BVH that refers to the instances are referred to as “top level BVHs.” In such an example, a given bounding box that can have multiple different LODs is associated with multiple instances, where each instance has the corresponding geometry for a particular LOD.

Once a LOD is selected, the ray tracing pipeline 300 causes ray traversal to continue for the ray in the portion of the BVH that corresponds to the selected LOD. Thus, the ray performs rendering operations (e.g., selecting a pixel color) for a given LOD by traversing the geometry for that LOD.

FIG. 6A illustrates an example in which the ray tracing pipeline 300 uses the cone characterization value 510 to select a geometry level of detail 602. As can be seen, the ray tracing pipeline 300 selects one of the geometry LODs based on the cone characterization value 510. As can also be seen, level of detail in this example is characterized by the number of vertices. The lower-detailed LOD geometry 602(1) defines a mesh with a smaller number of vertices than the higher-detailed LOD geometry 602(2). Although a specific set of geometry is illustrated, it should be understood that any technically feasible geometry can be used. Further, although a specific number of LODs is illustrated, it should be understood that the cone characterization value 510 can be used to select between any number of LODs.

Any technically feasible technique may be used to select an LOD based on the cone characterization value 510. In some examples, the ray tracing pipeline 300 has access to information that associates ranges of cone characterization values 510 with specific LODs. In some such examples, the information indicates, for each range of cone characterization values 510, which LOD is associated with that value. In operation, the ray tracing pipeline determines a cone characterization value 510, uses the information to identify the corresponding LOD, and then performs rendering operations (e.g., ray tracing operations) using the selected LOD. In some examples, the information correlating the ranges of cone characterization values 510 with LOD values (“correlation information”) is stored within the BVH itself or is stored in a data structure external to the BVH. In some examples, the correlation information is stored in the non-leaf node that also stores information for the bounding box that bounds the geometry of the LOD geometry. In some examples, the BVH stores non-leaf nodes that indicate that such nodes, or their children, have alternative embodiments as different LODs. In response to encountering such a non-leaf node while traversing a BVH for a ray, the ray tracing pipeline obtains a cone angle value 504, performs an intersection test to determine time to intersection, determines the cone characterization value 510 based on the time to intersection and cone angle value (as described elsewhere herein), and performs operations based on the cone angle value (such as selecting an LOD).

FIG. 6B represents an alternative or additional operation that the ray tracing pipeline 300 could perform based on the determined cone characterization value 510. Specifically, in FIG. 6B, once the ray tracing pipeline 300 has determined a cone characterization value 510, the ray tracing pipeline 300 uses that value to perform shader selection for underlying geometry. More specifically, ray tracing involves the use of a shader binding table 652. The shader binding table is a table that indicates which shader to use, and what parameters to use for that shader, given a set of inputs. In some examples, each entry in the shader binding table has an associated lookup address, and stores an address of the shader and set of parameters to use.

In various examples, such inputs include a shader selection value specified by the geometry (e.g., non-leaf node) hit by the ray, mesh identifier (“ID”) of that geometry the primitive ID of that geometry, instance ID, or other values. The shader selection value specified by the geometry is a value that is specified by and/or associated with the primitive that is hit by the ray. This value is simply a contribution to shader selection made by the primitive itself. The mesh ID is the identifier of the mesh (collection of primitives) that the primitive is a part of. The primitive ID is the unique ID for that primitive. The instance ID is the identifier of the instance that the primitive is a part of. In addition to all of these values, the ray tracing pipeline 300 is configured to select an entry 654 in the shader binding table 652 based on the cone characterization value 510. In some examples, the ray tracing pipeline 300 determines the cone characterization value 510 for any bounding box that is an ancestor of the primitive that is ultimately to be rendered using the selected entry 654 from the shader binding table 652. In some examples, the cone characterization value 510 is the value derived from the bounding box that is the most immediate ancestor (e.g., the parent) of the primitive being rendered according to the selected entry 654. In some examples, non-leaf nodes have multiple pointers to leaf nodes, each of which includes a bounding volume that bounds the geometry of the leaf node. In some such examples, the ray tracing pipeline 300 uses the cone characterization value 510 for that bounding volume in selecting the entry 654 for the primitive.

FIG. 7 illustrates operations for selecting geometry corresponding to a particular LOD based on a cone characterization value 510 while traversing through the BVH, according to an example.

More specifically, FIG. 7 includes a portion of a BVH 700 that includes a parent non-leaf node 702(1) and two child non-leaf nodes 702. The non-leaf node 702(1) has child descriptor 704(1), which includes a bounding box and a pointer to non-leaf node 702(2) and child descriptor 704(2) which includes a bounding box and a pointer to non-leaf node 702(3). If, during traversal of the BVH 700, the ray tracing pipeline 300 determines that the ray intersects the bounding volume specified by the child descriptor 704(1), then the ray tracing pipeline 300 continues traversal by following the pointer specified by the child descriptor 704(1), which leads to non-leaf node 702(2) (whose details are not shown in FIG. 7 for brevity). Similarly, if the ray tracing pipeline 300 determines that the ray intersects the bounding volume specified by child descriptor 704(2), then the ray tracing pipeline 300 continues traversal by following the pointer specified in the child descriptor 704(2), which leads to non-leaf node 702(3).

Non-leaf node 702(1) does not have any child descriptors 704 that contain LOD-related information, but non-leaf node 702(3) does, as shown in enlargement 706 (that is, enlargement of the non-leaf node 702(3), illustrating additional detail). Each of the child descriptors 704 of the non-leaf node 702(3) includes one or more flags and a child pointer. In addition, these child descriptors 704 include either bounds (i.e., a bounding volume that bounds all geometry that are descendants of the node pointed to by the child descriptor 704) or LOD data. Whether bounds or LOD data is included is based on the flags of the child descriptor 704. In some examples, if the flags indicate that the child descriptor 704 is an LOD child descriptor, then the child descriptor 704 contains LOD data and if the flags indicates that the child descriptor 704 is not an LOD child descriptor, then the child descriptor 704 includes a bounding volume.

In the course of traversing to a non-leaf node 702 that includes LOD data, the ray tracing pipeline 300 calculates a cone characterization value as described elsewhere herein. The ray tracing pipeline 300 compares this value to the LOD data of the child descriptors 704 that are part of a comparison set. A comparison set includes one child descriptor that does not have LOD data (which implicitly points to geometry for a “default” LOD), and one or more associated child descriptors that do have LOD data. In some examples, a child descriptor 704 that has LOD data is associated with a child descriptor that does not have LOD data if the child descriptor 704 having LOD data is immediately subsequent to (e.g., from left to right) another child descriptor 704 with LOD data that is, itself, associated with a child descriptor without LOD data, or if the child descriptor is, itself, immediately subsequent to a child descriptor 704 without LOD data. In other words, a contiguous set of child descriptors 704 with LOD data is considered to be associated with the preceding child descriptor 704 without LOD data. In the example of FIG. 7, child descriptor 704(5) and child descriptor 704(6) are associated with child descriptor 704(4).

The configuration of FIG. 7 allows the space that would be used for bounds (e.g., a bounding volume) in a different type of child descriptor 704 can instead be used to specify the LOD data, which allows LOD nodes to be included in a BVH without needing to explicitly allocate space for the LOD data in the nodes of that BVH. For each child descriptor 704 with LOD data, the bounding volume for that child descriptor is the bounds of the associated child descriptor 704.

In some examples, the LOD data includes a range of cone characterization values. The ray tracing pipeline 300 determines which range the calculated cone characterization value falls within, and thus determines which child descriptor 704 to traverse. If the calculated cone characterization value does not fall within any specified ranges of a comparison set, then the ray tracing pipeline 300 traverses the child descriptor 704 of the comparison set that includes the bounds (e.g., child descriptor 704(4) in FIG. 7).

In summary, when a ray tracing pipeline 300 arrives at a non-leaf node that includes at least one child descriptor 704 that includes LOD data (as indicated, e.g., by the flags), then the ray tracing pipeline 300 determines which child descriptor 704 of a comparison set to traverse by comparing a determined cone characterization value 510 with the LOD data of the child descriptors 704 of a comparison set. The ray tracing pipeline 300 identifies the child descriptor 704 whose LOD data matches the cone characterization value 510 (e.g., the cone characterization value 510 falls within that range) as the child descriptor 704 to traverse. If the cone characterization value 510 matches no such LOD data, then the ray tracing pipeline 300 identifies the child descriptor 704 of the set that stores the bounds as the child descriptor 704 to traverse. The ray tracing pipeline 300 does not traverse any such child descriptor 704, however, if the ray actually intersects the bounds for the set, where such bounds are defined by the child descriptor 704 of the comparison set that stores those bounds instead of the LOD data. It should be appreciated that these bounds are stored only once but are used for all child descriptors 704 of the comparison set, include the LOD nodes which do not explicitly store the bounds. The curved arrows of FIG. 7 illustrate this bounds sharing relationship.

FIG. 8 is a flow diagram of a method 800 for performing rendering operations using a cone angle value, according to an example. Although described with respect to the system of FIGS. 1-7, those of skill in the art will understand that any system configured to perform the steps of the method 800 in any technically feasible order falls within the scope of the present disclosure.

At step 802, the ray tracing pipeline 300 obtains a cone angle value for a ray cast operation for a ray against geometry specified by a BVH. The cone angle value is provided in any technically feasible manner. In one example, an application provides this value to a shader, which provides the value to the ray tracing pipeline 300 when traversal for the ray begins. In another example, a shader calculates the cone angle value, thus determining that value programmatically, based on any technically feasible information. In another example, the BVH itself includes the cone angle value. Any other technically feasible means for providing the cone angle value to the ray tracing pipeline 300 is possible.

At step 804, the ray tracing pipeline 300 calculates a cone characterization value based on the cone angle value and an intersection time. In an example, the ray tracing pipeline 300 determines the time to intersection of the ray and a bounding volume (e.g., the bounds of a child descriptor 704 of a comparison set), and determines the cone characterization value 510 based on the cone angle value and the time to intersection. As shown in FIG. 5, the cone characterization value 510 in this example is the base of the cone having the ray being cast as its axis, the origin of the ray as the apex, and the cone angle as the angle of the cone.

At step 806, the ray tracing pipeline 300 performs rendering operations based on the cone characterization value. In some examples, these operations include performing LOD selection. In some examples, the ray tracing pipeline 300 compares the cone characterization value to one or more values associated with LODs and selects an LOD based on this comparison. In some examples, the values associated with LODs are embedded in child descriptors 704 of a BVH. In such examples, in response to the ray tracing pipeline 300 determining that the cone characterization value matches one or more values associated with a particular LOD, the ray tracing pipeline 300 performs rendering operations using that LOD (e.g., by traversing to the portion of the BVH associated with that LOD). In some examples, each different LOD is associated with a different instance which is representative of the same set of geometry conceptually, but at a different LOD.

In other examples, the rendering operations comprise selecting a shader binding table entry 654 based on the cone characterization value 510. In various examples, this selection occurs based on a variety of parameters including the cone characterization value, as described elsewhere herein. In other examples, the rendering operations includes selecting a texture level of detail based on the cone characterization value.

Although the term “triangle” or “quad” is sometimes used here, this term can be replaced with “primitive” for similar, though broader meaning. The term “primitive” refers generally to geometric objects such as triangle, quad, or other geometry object.

It should be understood that any non-leaf node in a BVH can include LOD data as shown and described with respect to FIG. 7.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138, local data store 137, APD memory 139, ray tracing pipeline 300, ray generation shader 302, acceleration structure traversal stage 304, any hit shader 306, hit or miss unit 308, closest hit shader 310, or miss shader 312, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

* * *

What is claimed is:

1. A method comprising:
obtaining a cone angle value;
determining a cone characterization value based on the cone angle value and on a ray tracing operation; and
performing rendering operations based on the cone characterization value.

2. The method of claim 1, wherein the cone angle value is specified by an application or a shader program.

3. The method of claim 1, wherein the cone characterization value is based on a size of a base of a cone having an axis extending from an origin of a ray to a point of intersection of the ray with a bounding volume.

4. The method of claim 1, wherein the rendering operations comprise selecting a level of detail for geometry.

5. The method of claim 4, wherein the level of detail selected is based on a comparison of the cone characterization value and a size of a bounding volume.

6. The method of claim 4, wherein the level of detail selected is based on comparison information stored in a bounding volume hierarchy.

7. The method of claim 6, wherein the comparison information is stored in a sequence of one or more child descriptors, each marked as being a child descriptor containing level of detail information and a bounding volume for the sequence is stored in a parent of the sequence.

8. The method of claim 1, wherein the rendering operations comprise selecting a shader to execute based on the cone characterization value.

9. The method of claim 1, wherein the rendering operations comprise selecting a texture level of detail based on the cone characterization value.

10. A system comprising:
a memory configured to store data and instructions for ray tracing operations; and
a processor configured to perform ray tracing operations using the data and instructions, by:
obtaining a cone angle value;
determining a cone characterization value based on the cone angle value and on a ray tracing operation; and
performing rendering operations based on the cone characterization value.

11. The system of claim 10, wherein the cone angle value is specified by an application or a shader program.

12. The system of claim 10, wherein the cone characterization value is based on a size of a base of a cone having an axis extending from an origin of a ray to a point of intersection of the ray with a bounding volume.

13. The system of claim 10, wherein the rendering operations comprise selecting a level of detail for geometry.

14. The system of claim 13, wherein the level of detail selected is based on a comparison of the cone characterization value and a size of a bounding volume.

15. The system of claim 13, wherein the level of detail selected is based on comparison information stored in a bounding volume hierarchy.

16. The system of claim 15, wherein the comparison information is stored in a sequence of one or more child descriptors, each marked as being a child descriptor containing level of detail information and a bounding volume for the sequence is stored in a parent of the sequence.

17. The system of claim 10, wherein the rendering operations comprise selecting a shader to execute based on the cone characterization value.

18. The system of claim 10, wherein the rendering operations comprise selecting a texture level of detail based on the cone characterization value.

19. A non-transitory computer-readable medium storing instructions that, when executed by a processor, cause the processor to perform operations comprising:
obtaining a cone angle value;
determining a cone characterization value based on the cone angle value and on a ray tracing operation; and
performing rendering operations based on the cone characterization value.

20. The non-transitory computer-readable medium of claim 19, wherein the cone angle value is specified by an application or a shader program.
